(19) United States
(12) Patent Application Publication
(10) Pub. No.: US 2025/0059702 A1
(43) Pub. Date: Feb. 20, 2025

(54) A METHOD OF MODIFYING CELLULOSE FIBRES AND/OR CELLULOSE FABRIC

(71) Applicant: UEA Enterprises Limited, Norwich Norfolk (GB)

(72) Inventors: George Richard STEPHENSON, Norwich Norfolk (GB); Lloyd Henry SAYER, Norwich Norfolk (GB); Adam James WRIGHT, Norwich Norfold (GB)

(21) Appl. No.: 18/723,183

(22) PCT Filed: Dec. 14, 2022
(86) PCT No.: PCT/GB2022/053227

§ 371 Date: Jun. 21, 2024

(30) Foreign Application Priority Data
Dec. 22, 2021 (GB) 2118757.0

(51) Int. Cl. D06M 13/203; D06B 3/18; D06M 101/06

(52) U.S. Cl. CPC D06M 13/203; D06B 3/18; D06M 2101/06; D06M 2200/12

(57) ABSTRACT

A method of modifying one or more cellulose fibres and/or cellulosic fabric, wherein the method comprises: (a) providing an aqueous solution comprising at least one hydrocarbon acid and at least one acid catalyst and/or at least one emulsifier; (b) treating one or more cellulose fibres and/or cellulosic fabric with the aqueous solution provided in step (a) to couple the one or more cellulose fibers and/or cellulosic fabric with the at least one hydrocarbon acid.

### TECHNICAL FIELD

The present invention generally relates to methods of modifying cellulose fibres and/or cellulosic fabric, cellulose-based composite materials comprising modified cellulose fibres and/or cellulosic fabric obtained by these methods and use of an aqueous solution comprising at least one hydrocarbon acid and at least one acid catalyst and/or at least one emulsifier for the modification of one or more cellulosic fibres and/or cellulosic fabric.

As used herein, the expression “cellulose-based composite materials” particularly means composite materials in which modified cellulose fibres are used as reinforcing fibres, analogously to glass fibres in glass fibre composite materials.

### BACKGROUND

WO 2019/180449 teaches that cellulose fibres and/or cellulosic fabrics which have been modified using one or more hydrocarbon chains, for example one or more hydrocarbon acids, can be used as reinforcing fibres in composite materials. The composite materials so formed were found to have good durability, good water resistance and good structural strength and engineering performance. WO2019/180449 is incorporated herein by reference.

Monteiro et al, “Selection of high strength natural fibers”, Revista Materia, 2010, 15, page 488, cited in Mohammed et al, “A Review on Natural Fiber Reinforced Polymer Composite and its Applications”, International Journal of Polymer Science, 2015, Article ID 243947, http://dx.doi.org/10.1155/2015/243947, the contents of both of which are incorporated herein by reference, describes the use of cellulose-based composite materials in which modified cellulose fibres are used as a glass fibre replacement in the composite materials.

As examples of such research there may be cited:
Bengtsson et al, “Extrusion and mechanical properties of highly filled cellulose fibre-polypropylene composites”, Composites: Part A, 2007, 38, page 1922; and
Zini and Scandola, “Green Composites: An Overview”, Polymer Composites, 2011, page 1905;
   the contents of both of which are incorporated herein by reference.

In existing processes, in order to obtain the required composite materials, such cellulose fibres and/or cellulosic fabrics were treated using expensive and potentially hazardous organic solvents. It is desirable to provide a method which avoids the use of organic solvents, is cheaper and safer and therefore more suitable for commercial use on a production line.

### SUMMARY

According to a first aspect of the present invention, there is provided a method of modifying one or more cellulose fibres and/or cellulosic fabric, wherein the method comprises: (a) providing an aqueous solution comprising at least one hydrocarbon acid and at least one acid catalyst and/or at least one emulsifier; (b) treating one or more cellulose fibres and/or cellulosic fabric with the aqueous solution provided in step (a) to couple the one or more cellulose fibres and/or cellulosic fabric with the at least one hydrocarbon acid.

The aqueous solution provided in step (a) above may be an emulsion.

The at least one emulsifier may be a synthetic emulsifier or a natural emulsifier.

The at least one acid catalyst may be selected from hydrochloric acid, sulfuric acid, nitric acid, methanesulfonic acid, p-toluenesulfonic acid, phosphoric acid, oxalic acid, boric acid, citric acid, trichloroacetic acid or combinations thereof.

Preferably, the at least one acid catalyst may comprise oxalic acid.

The method may further comprise step (c), wherein the one or more cellulose fibres and/or cellulose fabric are squeezed using rollers to remove excess aqueous solution.

The method may further comprise step (d) wherein the treated one or more cellulose fibres and/or cellulosic fabric are heated to evaporate water and to effect esterification.

The method may further comprise step (e) wherein the one or more cellulosic fibres and/or cellulosic fabric are washed.

The method may further comprise a drying step (f).

The at least one hydrocarbon acid may have a carbon number of at least about 6 and equal to or less than about 30.

The at least one hydrocarbon acid may be a fatty acid.

Preferably, the at least one hydrocarbon acid may be a fatty acid sourced from naturally occurring triglycerides or other natural sources.

Preferably, the at least one hydrocarbon acid may be linoleic acid.

According to a second aspect of the present invention, there is provided a composite material comprising one or more modified cellulose fibers and/or modified cellulosic fabric embedded therein obtained by the method according to the first aspect of the present invention.

The composite material may be biodegradable.

The composite material may be water resistant.

According to a third aspect of the present invention, there is provided a use of an aqueous solution comprising at least one hydrocarbon acid and at least one acid catalyst and/or at least one emulsifier for the modification of one or more cellulosic fibers and/or cellulosic fabric.

The aqueous solution may form an emulsion which is stable for a time which is equal to or greater than 3 hours before phase separation.

The details, examples and preferences provided in relation to any particular one or more of the stated aspects of the present invention will be further described herein and apply equally to all aspects of the present invention. Any combination of the embodiments, examples and preferences described herein in all possible variations thereof is encompassed by the present invention unless otherwise indicated herein, or otherwise clearly contradicted by context.

### BRIEF DESCRIPTION OF THE FIGURES

The present invention may further be described with reference to the following non-limiting figures in which:

FIG. 1 shows a repeating unit of cellulose.

FIG. 2 shows a representative IR spectrum of a modified cellulose fabric from a lab scale method.

FIG. 3 shows (A) a scanning electron microscopy (SEM) image and (B) the distribution of fibre diameters for a modified cellulose fabric from a lab scale method; (C) a SEM image and (D) the distribution of fibre diameters for modified cellulose fabric from a production scale method.

FIG. 4 shows X-ray powder diffraction (XRD) plots of intensity against 20 for untreated fabric (A), for a modified cellulose fabric from a lab scale method (B), and for a modified cellulose fabric from a production scale method (C).

FIG. 5 shows (A) thermogravimetric (TGA) and (B) derivative thermogravimetry (DTG) results for a modified cellulose fabric from a lab scale method; and (C) TGA and (D) DTG results for a modified cellulose fabric from a production scale method.

FIG. 6 shows a comparison of % weight gain after immersion in water for four days for (A) untreated fabric; (B) a modified cellulose fabric from a production scale method; (C) a modified cellulose fabric from a lab scale method.

### DETAILED DESCRIPTION

There is provided herein a method of modifying one or more cellulose fibres and/or cellulosic fabric wherein the method comprises providing an aqueous solution comprising at least one hydrocarbon acid and at least one acid catalyst and/or at least one emulsifier; treating one or more cellulose fibres and/or cellulosic fabric with the aqueous solution provided to couple the one or more cellulose fibres and/or cellulosic fabric with the at least one hydrocarbon acid.

Cellulose Fibres and/or Cellulosic Fabric

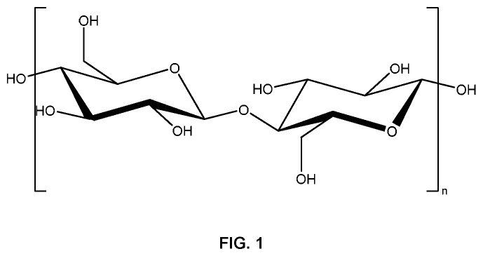

Cellulose is a natural polymer of B (1→4) linked D-glucose units, of length varying from a few hundred to several thousand pyranose rings. FIG. 1 shows the repeating unit of cellulose. There are three reactive hydroxy groups in each glucose. Two consecutive glucose units are rotated at an angle of 180° in the plane from each other, due to the bond angle preferences of the bridging acetal (O—C—O) moieties, so that a single unit of the polymer consists of two glucose rings. The chain has an extensive hydrogen bonding network between the ring and side-chain hydroxyl groups both in the chain and between adjacent chains, giving stiffness and hence a degree of crystallinity to the polymer. As a consequence, solid state cellulose contains both amorphous (low order) and crystalline (high order) regions.

Cellulose chain length varies with the source. From wood pulp the length ranges from 300 to 1700 repeating units. Plant fibres, such as cotton, are 800 to 10,000 units. Microcrystalline celluloses of 150 to 300 units are prepared by chemical partial chain degradation of longer cellulose polymers.

The three hydroxyl groups present on each glucose component of the polymer are each able to undergo alkylation and acylation reactions using standard chemical reaction conditions. Methylcellulose can be prepared readily by treatment of an aqueous suspension of cellulose in water with sodium hydroxide, followed by addition of chloromethane or dimethyl sulfate. It is commercially available in a number of different degrees of methylation and chain length.

Cellulose may, for example, be extracted or obtained from plants and/or macroorganisms and/or microorganisms such as tunicates or bacteria using methods known to those skilled in the art. For example, cellulose may be extracted from one or more of flax, cotton, hemp, coir, jute, manila and wood pulp. Cellulose may be extracted by prehydrolysis with mineral acids or alkali followed by pulping (e.g., using NaOH), followed by bleaching (e.g., using sodium chlorite, hydrogen peroxide or ozone). Cellulose may also be obtained from commercial sources.

The cellulose fibres used to prepare the modified cellulose fibres described herein may, for example, be in the form of a fabric (cellulosic fabric). The term “fabric” refers to a material wherein a plurality of cellulose fibres are interlaced together, for example by weaving, knitting, knotting, felting, spreading, crocheting, looping, braiding, lacing, bonding or any other suitable methods. The fabric may, for example, be a woven fabric. The fabric may, for example, have a weight ranging from about 10 gsm to about 1000 gsm, for example from about 50 gsm to about 500 gsm, for example from about 100 gsm to about 400 gsm, for example from about 200 gsm to about 400 gsm. The dimensions of the fabric may vary depending on their desired purpose. Fabric dimensions may include, but are not limited, to 3×3 cm square, 30×30 cm square or fabrics with full widths of 1 m or 1.27 m. The fabric may, for example, comprise one or more different fibres in addition to the one or more cellulose fibres. For example, the fabric may comprise one or more polymer fibres, for example one or more polypropylene fibres, and/or hemicellulose and/or lignin in addition to the one or more cellulose fibres.

The cellulose used to prepare the modified cellulose fibres and/or modified cellulose fabric described herein may, for example, not be microfibrillated cellulose. The cellulose fibres (e.g., the cellulose fibres used to make the cellulosic fabric) may, for example, have an average diameter equal to or greater than about 1 μm, for example equal to or greater than about 10 μm, for example equal to or greater than about 20 μm. For example, the cellulose fibres (e.g., the cellulose fibres used to make the cellulosic fabric) may have an average diameter equal to or less than about 100 μm or equal to or less than about 75 μm or equal to or less than about 50 μm or equal to or less than about 20 μm. The average diameter of the cellulose fibres may be measured by scanning electron microscopy (SEM).

The cellulose fibres may, for example, be derived from any suitable source. For example, the cellulose fibres may be derived from a natural source or may be man-made. For example, the cellulose may be derived from cotton, jute, flax, hemp, ramie, sisal, coconut husk, bamboo or a combination of one or more thereof. For example, the cellulose fibres may be man-made rayon fibres.

The cellulose fibres used to prepare the modified cellulose fibres described herein may be woven flax fibres (a flax fibre cellulosic fabric), which may, for example, be commercially available.

### Aqueous Solution

The aqueous solution comprises at least one hydrocarbon acid and at least one acid catalyst and/or at least one emulsifier. The term “aqueous solution” refers to a solution in which the solvent is water. The aqueous solution may be an emulsion. The term “emulsion” refers to a mixture of two or more liquids that are normally immiscible.

The aqueous solution may form an emulsion in the absence of at least one emulsifier. It is understood that the presence of the at least one hydrocarbon acid itself may form a transient emulsion in water.

The aqueous solution may also require the presence of at least one emulsifier to form an emulsion.

The aqueous solution may have an acidic pH, for example a pH from about 1 to about 6.

There is also provided herein a use of an aqueous solution comprising at least one hydrocarbon acid and at least one acid catalyst and/or at least one emulsifier for the modification of one or more cellulose fibres and/or cellulosic fabric.

The emulsion may have a lifetime suitable for use on a commercial production line for fabric treatment. The aqueous solution may form an emulsion which is stable for a time which is equal to or greater than 1 hour before phase separation. For example, the aqueous solution may form an emulsion that is stable for a time which is equal to or greater than 1.5 hours before phase separation, equal to or greater than 2 hours before phase separation, equal to or greater than 2.5 hours before phase separation, equal to or greater than 3 hours before phase separation, equal to or greater than 3.5 hours before phase separation, equal to or greater than 4 hours before phase separation, equal to or greater than 4.5 hours before phase separation, or equal to or greater than 3 hours before phase separation. The aqueous solution may form an emulsion which is stable for a time which is equal to or greater than 3 hours before phase separation. The advantage of producing such an emulsion is that it can be produced on a bulk scale but will be stable enough to last until required.

### Hydrocarbon Acid

The term “hydrocarbon acid” refers to carboxylic acids (R—C(O) OH), where the R group is a hydrocarbon substituent (a substituent comprising or consisting of hydrogen and carbon atoms and optionally other functional groups, which may, for example, include heteroatoms such as oxygen, sulfur, nitrogen, phosphorous and halogens).

The hydrocarbon chain (R group) may not include any functional groups (i.e., consists of hydrogen and carbon atoms). Thus, the at least one hydrocarbon acid may be a monobasic acid (i.e., contain only one carboxylic acid group). For example, all of the hydrocarbon acid(s) may be monobasic acid(s).

The R group may be a linear hydrocarbon substituent (i.e., does not include any cyclic groups). The R group may, for example, be a straight (i.e., non-branched) or branched linear hydrocarbon substituent. At least one hydrocarbon acid may be a linear hydrocarbon acid. For example, all of the hydrocarbon acid(s) may be linear hydrocarbon acid(s). At least one hydrocarbon acid may be a straight chain linear hydrocarbon acid. For example, all of the hydrocarbon acid(s) may be straight chain linear hydrocarbon acid(s).

The R group may, for example, be an aliphatic hydrocarbon substituent. At least one hydrocarbon acid may be an aliphatic hydrocarbon acid. For example, all of the hydrocarbon acid(s) may be aliphatic hydrocarbon acid(s).

At least one hydrocarbon acid may be a linear aliphatic monobasic hydrocarbon acid. For example, all of the hydrocarbon acid(s) may be linear aliphatic monobasic hydrocarbon acid(s). At least one of the linear aliphatic monobasic hydrocarbon acids may be an unsaturated linear aliphatic monobasic hydrocarbon acid. At least one hydrocarbon acid may be a straight chain linear aliphatic monobasic hydrocarbon acid. For example, all of the hydrocarbon acid(s) may be straight chain linear aliphatic monobasic hydrocarbon acid(s). At least one of the straight chain linear aliphatic monobasic hydrocarbon acids may be unsaturated straight chain linear aliphatic monobasic hydrocarbon acid.

The hydrocarbon acids, described herein may have a carbon number of at least about 6. This means that the hydrocarbon acids, may have at least about 6 carbon atoms. The hydrocarbon acids, described herein may, for example, have a carbon number equal to or less than about 30. For example, the hydrocarbon acids, may have a carbon number ranging from about 8 to about 30 or from about 10 to about 30 or from about 12 to about 28 or from about 15 to about 25 or from about 15 to about 20. For example, the hydrocarbon acids, may have a carbon number of 6, 7, 8, 9, 10, 11, 12, 13, 14, 15, 16, 17, 18, 19, 20, 21, 22, 23, 24, 25, 26, 27, 28, 29 or 30. For example, the hydrocarbon acids, may have a carbon number of 18.

At least one of the hydrocarbon acids, may be unsaturated. The unsaturated hydrocarbon acid may include one or more double bonds, for example two, three, four, five or six double bonds. For example, all of the hydrocarbon acids, may be unsaturated. The at least one hydrocarbon acid described herein may be a fatty acid, for example, a fatty acid sourced from naturally occurring triglycerides or other natural sources. The hydrocarbon acid may, for example, be derived from a plant oil, for example a fatty acid derived from plant oil. For example, the hydrocarbon acids may be derived from linseed oil, soy-bean oil, rapeseed oil, hemp oil or a combination thereof. The plant oil may, for example, undergo hydrolysis (saponification) of triglycerides found in the plant oil in order to obtain the hydrocarbon acids described herein. Hydrolysis may occur by heating with potassium hydroxide in a solvent such as ethanol or aqueous ethanol. The reaction mixtures may be quenched by pouring into water and then may be extracted with ether or hexane and then acidification of the resulting salt solution. The resultant products may, for example, be referred to as acids, for example linseed acid, rapeseed acid, soybean acid and hempseed acid.

For example, linseed oil is a triglyceride including the hydrocarbon acids alpha-linolenic acid (e.g., about 51.9-55.2%), palmitic acid (e.g., about 7%), stearic acid (e.g., about 3.4-4.6%), oleic acid (e.g. about 18.5-22.6%) and linoleic acid (e.g. about 14.2-17%). The table below shows the wt % composition of different hydrocarbon acids in plant oils following saponification.

| | | | | | α- | γ- | | | |
|---|---|---|---|---|---|---|---|---|---|
| | | | | | Linolenic | Linolenic | Stearidonic | | |
| | Palmitic | Stearic | Oleic | Linoleic | acid | acid | acid | | % |
| Plant oil | acid | acid | acid | acid | (ALA) | (GLA) | (SDA) | Total | PUFA |
| hempseed | 5 | 2 | 9 | 56 | 22 | 4 | 2 | 100 | 84 |
| linseed | 6 | 3 | 15 | 15 | 61 | 0 | 0 | 100 | 76 |
| Rapeseed | 4 | | 60 | 23 | 13 | 0 | 0 | 100 | 36 |
| Soybean | 10 | 4 | 23 | 55 | 8 | 0 | 0 | 100 | 63 |

Therefore, the at least one hydrocarbon acid may comprise one or more of linolenic acid (alpha and/or gamma), palmitic acid, stearic acid, oleic acid, linoleic acid and stearidonic acid. The structures of each are shown below.

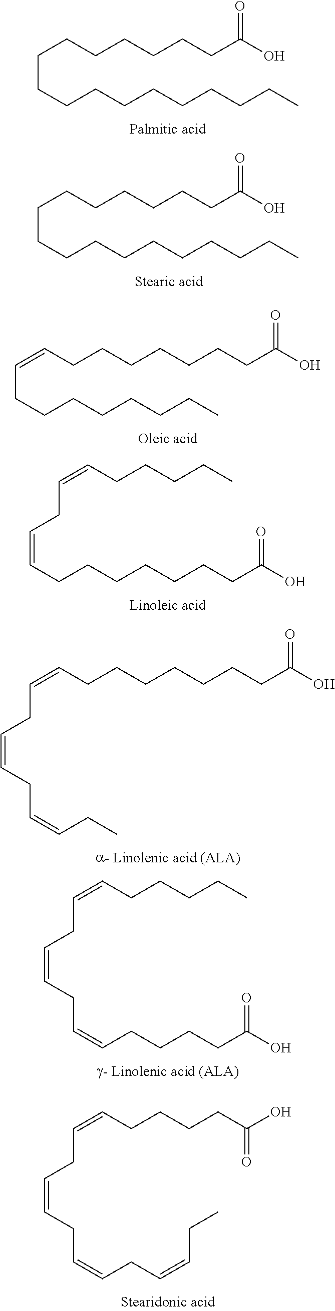

The at least one hydrocarbon acid may comprise rapeseed acid. For example, the at least one hydrocarbon acid may comprise about 50 wt % to about 100 wt % rapeseed acid, for example about 50 wt % to about 80 wt %, for example about 55 wt % to about 75 wt %, for example from about 58 wt % to about 74 wt % rapeseed acid.

The at least one hydrocarbon acid may comprise linoleic acid. For example, the at least one hydrocarbon acid may comprise about 50 wt % to about 100 wt % linoleic acid, for example about 50 wt % to about 80 wt %, for example about 55 wt % to about 75 wt %, for example from about 58 wt % to about 74 wt % linoleic acid.

The hydrocarbon acid may be present in a concentration of 8% by weight.

### Acid Catalyst

The aqueous solution may comprise at least one acid catalyst.

The term “acid catalyst” refers to an acidic species capable of catalysing a chemical reaction, for example, by acting as a source of protons.

The at least one acid catalyst may be a carboxylic acid or a non-carboxylic acid. For example, the at least one acid catalyst may be selected from hydrochloric acid sulfuric acid, nitric acid methanesulfonic acid, p-toluenesulfonic acid, phosphoric acid, oxalic acid, boric acid, citric acid, trichloroacetic acid, or combinations thereof. The at least one acid catalyst may be selected from methanesulfonic acid, oxalic acid, citric acid, trichloroacetic acid, and combinations thereof. Preferably, the at least on acid catalyst comprises oxalic acid, for example oxalic acid dihydrate.

The acid catalyst may be present in the aqueous solution in a concentration of 0.01 M to 5M, for example 0.01 M to 2M. The acid catalyst may be present in the aqueous solution in a concentration of 1M. The acid catalyst may be present in the aqueous solution in a concentration of 0.16 M.

### Emulsifier

The aqueous solution may comprise at least one emulsifier.

The term “emulsifier” refers to a substance that stabilises an emulsion by increasing the time before phase separation.

The at least one emulsifier may be a synthetic emulsifier or natural emulsifier. The term “natural emulsifier” refers to emulsifiers which are derived from natural sources such as plants. Natural emulsifiers may be extracted or chemically processed; however, they are considered to be natural because they are derived from a natural source. The term “synthetic emulsifier” refers to emulsifiers which are synthetically derived in a chemical process.

Suitable synthetic emulsifiers may include, but are not limited to, 4-dodecylbenzenesulfonic acid (DBSA), furfural sulfonic acid, sodium dodecyl sulfate (SDS), ammonium lauryl sulfate, sodium lauryl ether sulfate (SLES), sodium myreth sulfate, and/or sodium stearoyl lactylate.

Suitable natural emulsifiers may include, but are not limited to, soy lecithin, soy phospholipids or other suitable phospholipids, whey proteins, caseins, gelatin, egg proteins, soy proteins, pea proteins, gum arabic, terpene glycosides (e.g., monoterpene glycoside, sesquiterpene glycoside, diterpene glycoside and triterpene glycoside), saponin glycosides starch, pectins, and/or galactomannans.

Preferably, the at least one emulsifier may include 4-dodecylbenzenesulfonic acid (DBSA), sodium dodecyl sulfate (SDS), soy phospholipids, N-lauroylsarcosine sodium salt or Synperonic F108 [a poly(ethylene glycol)-block-poly(propylene glycol)-block-poly(ethylene glycol) oligomer].

If the at least one emulsifier is acidic, for example DBSA or furfural sulfonic acid, it may act as a proton source, such that an acid catalyst is not required.

The at least on emulsifier may be present in the aqueous solution in a concentration from about 0.01 moles/litre to 1 mole/litre, for example 0.1 moles/litre to 0.5 moles/litre.

### Buffer

The aqueous solution may further comprise at least one buffer. The term “buffer” refers to an aqueous solution consisting of a mixture of a weak acid and its conjugate base or a weak base and its conjugate acid, capable of keeping the pH of a solution at a near constant value.

The at least one buffer may include a citrate, phosphate, or acetate buffer system. For example, the at least one buffer may include sodium dihydrogen phosphate, potassium dihydrogen phosphate, sodium citrate/citric acid, acetic acid/sodium acetate.

The at least one buffer may have a concentration of 0.5M to 2M, for example, 1M.

### Treatment

The one or more cellulose fibres and/or cellulosic fabric are treated with the aqueous solution to couple the one or more cellulose fibres and/or cellulosic fabric with the at least one hydrocarbon acid.

### Coupling

The one or more cellulose fibres and/or the cellulosic fabric may be covalently coupled with the at least one hydrocarbon acid (e.g., covalently couple the at least one hydrocarbon acid to the cellulose fibres in the cellulosic fabric). The one or more cellulose fibres and/or cellulosic fabric may be modified to covalently couple the at least one hydrocarbon acid to the one or more cellulose fibres and/or cellulosic fabric by any suitable attachment functionality. The one or more cellulose fibres and/or cellulosic fabrics may be modified to covalently couple the at least one hydrocarbon acid to the one or more cellulose fibres and/or cellulosic fabric by any bonding with one of the OH groups present on the sugar units in the one or more cellulose fibres and/or cellulosic fabric or by replacing one of the OH groups present on the sugar units in the one or more cellulose fibres and/or cellulosic fabric. In particular, the at least one hydrocarbon acid may be covalently coupled to the one or more cellulose fibres and/or cellulosic fabric by bonding with one of the OH groups present on the sugar units in the one or more cellulose fibres and/or cellulosic fabric. The one or more cellulose fibres and/or cellulosic fabric may be covalently coupled with the at least one hydrocarbon acid with an ester linkage ((R—(CO)—O—R′) or (R—O—(CO)—R′)).

The one or more cellulose fibres and/or cellulosic fabric may be coupled to the at least one hydrocarbon acid by an esterification reaction. The one or more cellulose fibres and/or cellulosic fabric may be coupled by esterification to the at least one hydrocarbon acid by reacting the one or more cellulose fibres and/or cellulosic fabric with the at least one hydrocarbon acid in the presence of the acid catalyst and/or acidic emulsifier. That is to say, at least one acid catalyst and/or acidic emulsifier may act as an ester coupling reagent in the modification of the one or more cellulose fibres and/or cellulosic fabric. Ester coupling reagents may be used to assist in the esterification of the hydroxyl groups in the one or more cellulose fibres and/or cellulosic fabric, for example in the glucose in the cellulosic fibres.

The reaction may proceed in a manner similar to that shown in reaction scheme 1 below.

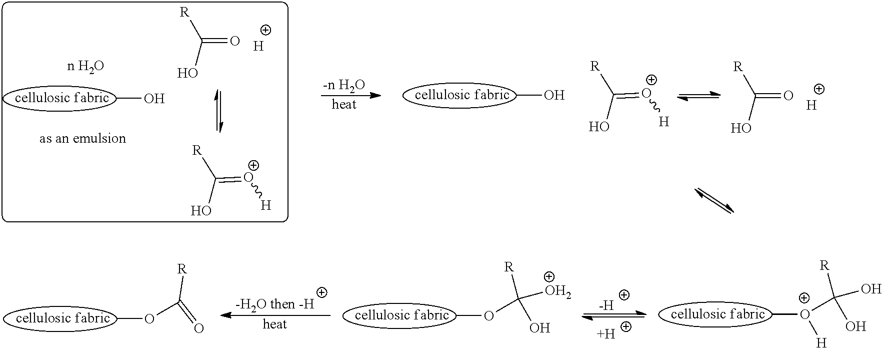

### Further Steps

The method may further comprise a step wherein the one or more cellulose fibres and/or cellulosic fabric are squeezed using rollers. The one or more cellulose fibres and/or cellulosic fabric may be squeezed using rollers to remove excess solution, for example, from treatment with the aqueous solution.

The method may further comprise a step wherein the treated one or more cellulose fibres and/or cellulosic fabric are heated. The one or more cellulose fibres and/or cellulosic fabric may be heated to evaporate excess aqueous solution. The one or more cellulose fibres and/or cellulosic fabric may be heated to evaporate excess water. The one or more cellulose fibres and/or cellulosic fabric may be heated to effect coupling between the one or more cellulose fibres and/or cellulosic fabric and the at least one hydrocarbon acid. The one or more cellulose fibres and/or cellulosic fabric may be heated to effect esterification of the one or more cellulose fibres and/or cellulosic fabric and the at least one hydrocarbon acid. The one or more cellulose fibres and/or cellulosic fabric may be heated in two stages. The first heating stage may be to evaporate excess aqueous solution/water. The second heating stage may be to effect coupling/esterification of the one or more cellulose fibres and/or cellulosic fabric and the at least one hydrocarbon acid.

The one or more cellulose fibres and/or cellulosic fabric may be heated at a temperature between 80° C. to 180° C., for example 90° C. to 160° C., for example 100° C. to 140° C. The one or more cellulose fibres and/or cellulosic fabric may be heated at a temperature of 120° C. Temperatures recited refer to temperatures at atmospheric pressure.

The one or more cellulose fibres and/or cellulosic fabric may be heated for a time of between 30 seconds to 10 minutes, for example between 1 minute to 8 minutes, for example between 2 minutes to 6 minutes, for example between 2 minutes to 4 minutes. The one or more cellulose fibres and/or cellulosic fabric may be heated for a time of 3 minutes.

The method may further comprise a step wherein the one or more cellulose fibres and/or cellulosic fabric is washed. Washing may also be known as scouring. The one or more cellulose fibres and/or cellulosic fabric may be washed prior to treatment. The one or more cellulose fibres and/or cellulosic fabric may be washed after treatment. For example, the one or more cellulose fibres and/or cellulosic fabric may be washed after a heating step. The one or more cellulose fibres and/or cellulosic fabric may be washed to remove excess or unspent reagents. The one or more cellulose fibres and/or cellulosic fabric may be washed with one or more solvents. The one or more solvents may be aqueous solvents and/or non-aqueous solvents. The one or more solvents may be a combination of aqueous and non-aqueous solvents and detergents. For example, the one or more cellulose fibres and/or cellulosic fabric may be washed with an aqueous sodium carbonate solution, water and ethanol or the one or more cellulose fibres and/or cellulose fabric may be washed with an aqueous sodium carbonate solution and water. The one or more cellulose fibres and/or cellulosic fabric may be dried after each washing solvent or may be washed consecutively by selected washing solvents and then dried.

The method may further comprise a step wherein the cellulose fibres and/or cellulosic fabric is dried to remove as much of the remaining moisture as possible.

The one or more cellulose fibres and/or cellulosic fabric may be dried at a temperature between 60° C. to 160° C., for example 80° C. to 140° C., for example 100° C. to 120° C. The one or more cellulose fibres and/or cellulosic fabric may be heated at a temperature of 110° C.

The one or more cellulose fibres and/or cellulosic fabric may be dried for a time of between 1 minute to 50 minutes, for example between 2 minutes to 40 minutes, for example between 3 minutes to 30 minutes. The one or more cellulose fibres and/or cellulosic fabric may be heated for a time of 40 minutes. The one or more cellulose fibres and/or cellulose fabric may be heated for a time of 9 minutes. The one or more cellulose fibres and/or fabric may be heated for a time of 4 minutes.

Modified Cellulosic Fibres and/or Cellulosic Fabric

The one or more cellulose fibres and/or cellulosic fabric may be modified to covalently couple the at least one hydrocarbon acid to the one or more cellulose fibres and/or cellulosic fabric (e.g., covalently couple the at least one hydrocarbon acid to the one or more cellulose fibres in the cellulosic fabric), for example by an ester covalent linkage.

Infrared spectroscopy may be used to identify chemical bonds in the modified cellulosic product and thus confirm the identity of the product. For example, the presence of ester covalent linkages may be confirmed by Fourier Transform Infrared Spectroscopy (FTIR), using an Attenuated Total Reflectance (ATR) sampling stage, by identifying the presence of a vibrational band at about 1734 to 1736 cm-1, corresponding to the ester carbonyl (C═O) stretch.

X-ray powder diffraction (XRD) may be used to analyse the crystalline structure of the cellulose fabric. For example, the % crystallinity, crystallite size, and interplanar distance can be measured.

The “degree of substitution” may refer to the % of monomer units (e.g., anhydroglycose units in cellulose) having a hydrocarbon acid group attached. The one or more modified cellulose fibres and/or cellulosic fabric may, for example, have a degree of substitution of at least about 0.1%, for example at least about 0.5% or at least about 1%. For example, the one or more cellulose fibres and/or cellulosic fabric may have a degree of substitution ranging from about 0.1% to about 100%, for example from about 0.1% to about 60% or from about 0.1% to about 50% or from about 0.1% to about 40% or from about 0.1% to about 30% or from about 0.1% to about 20% or from about 0.1% to about 15% or from about 0.1% to about 10%, depending on the proportion of accessible OH groups.

These modified cellulose fibres and/or modified cellulosic fabric advantageously provide improved durability, improved resistance to water uptake and structural strength/engineering performance. The modified cellulose fibres and/or cellulosic fabric may be further advantageous in that they may be biomaterials, may be recyclable and bioavailable, and may have a relatively low cost and low weight.

### Composite Material

There is provided herein a composite material comprising one or more modified cellulose fibres and/or modified cellulosic fabric embedded therein obtained by the method disclosed herein.

The composite material may be biodegradable, meaning that it can be disintegrated by biological means (e.g., by enzymes and/or bacteria and/or fungi).

The composite material may be water resistant, meaning that it demonstrates improved water-resistant properties.

The composite material may further comprise a matrix. The matrix may, for example, be a polymer matrix. The matrix may, for example, not be a cement matrix. The matrix may comprise a resin. The resin used for the matrix of the composite material may, for example, be a biodegradable resin, meaning that it can be disintegrated by biological means (e.g., by enzymes and/or bacteria and/or fungi). The resin may, for example, be a biosourced resin or a partially biosourced resin. The resin may, for example, be biocompatible.

The resin may, for example, be selected from polyamides, polyureas, polyurethanes, polyanhydrides, poly(vinyl alcohol), poly(ethylene glycol), polyester resins (e.g. unsaturated polyester resins), polypropylene resins (PP), polylactic acid (PLA), poly(ε-caprolactone), poly(alkylene succinate), epoxy resins, fatty acid-based resins, starch-based resins, cellulose-based resins (e.g. carboxymethylcellulose or hydroxyethyl cellulose), poly(amino acids) (e.g. poly(amino acids) with free carboxylic groups such as poly(aspartic acid) and poly(glutamic acid)), polyfurfuryl alcohol (PFA), polybenzoxazine (PBO) or a combination of one or more thereof.

### EXAMPLES

### Measurement Methods

### Scanning Electron Microscopy

Scanning electron microscope (SEM) images were obtained using a Gemini SEM 300 SEM (Zeiss, Oberkochen, Germany). All samples were attached to SEM stubs using double-sided adhesive tape and then coated with gold using a Polaron SC7640 sputter gold coater (Quorum Technologies, Lauphton, UK) prior to imaging, operating at an accelerating voltage of 5 kV. Diameters of the fibres were analysed by the ImageJ software.

### X-Ray Diffraction

X-ray powder diffraction (XRD) was measured using a Rigaku Smartlab SE® powder diffractometer (Rigaku Europe SE, Neu-Isenburg, Germany). Diffraction scattering patterns were collected at room temperature using monochromatic Cu Kα radiation (λ=1.5418 Å) with 20 in the range from 0° to 60° with a step width of 0.02° and a scan speed of 4° min⁻¹.

### Thermo Gravimetric Analysis

Thermal gravimetric analysis (TGA) was performed using a Waters TA5500 (TA Instruments, Wilmslow, UK) simultaneous thermal analyser. 15-20 mg of each sample was heated in an aluminium pan from 30 to 600° C. at a heating rate of 10° C. min⁻¹ under a constant nitrogen flow of 50 mL min⁻¹. DTG curves were obtained by performing a first derivative calculation on the % weight loss data from TGA using Waters Trios software.

### Weight Gain Measurement

Three nominally 1 cm square specimens from each fabric sample were weighed to four decimal places. Each sample was immersed in deionised water. After 24 hours the sample was removed from the water, dried on absorbent paper and immediately weighed. This process was repeated for every 24 hours over several weeks until the fabric reached saturation. The weight gain curves were plotted for % weight change (Wᵤₚₜₐₖₑ), or normalised weight gain (Wₜₙ), vs total cumulative soaking time. The difference in weight between the sample in dry condition and after water immersion at time t was calculated as follows:

$${W}_{uptake} ( \% ) = \frac{{W}_{t} - {W}_{0}}{{W}_{0}} \times 100$$

Where Wᵤₚₜₐₖₑ=Water uptake, Wₜ=weight of the sample at immersion time t, W₀=initial weight of the sample, and Wₜₙ=weight of specimen at time t corrected to correspond to 1 g of dry fabric.

### Example 1—Lab Scale Method 1

8.75 mL water, 0.23 g DBSA and 0.81 g linoleic acid (technical grade) were mixed and shaken vigorously to form an emulsion. 0.2 g oxalic acid dihydrate was added to the stirred emulsion. A 3×3 cm square of cellulosic fabric was dipped in the emulsion for 1 second before being squeezed to remove excess emulsion. The wetted fabric was heated in a fan assisted oven at 140° C. for 4 minutes. The fabric was then washed with 20 mL of 1M aqueous sodium carbonate solution, 20 ml of water and 20 mL of ethanol before being dried in a fan oven at 60° C. for 40 minutes.

### Example 2—Lab Scale Method 2

8.75 ml water, 0.23 g DBSA and 0.81 g linoleic acid (technical grade) were mixed and shaken vigorously to form an emulsion. 0.2 g oxalic acid dihydrate was added to the stirred emulsion. A 3×3 cm square of cellulosic fabric was dipped in the emulsion for 1 second before being squeezed to remove excess emulsion. The wetted fabric was heated in a fan assisted oven at 60° C. for 9 minutes to dry it and then at 120° C. for 3 minutes. The fabric was then washed with 20 mL of 1M aqueous sodium carbonate solution, 20 ml of water and 20 mL of ethanol before being dried in a fan oven at 60° C. for 40 minutes.

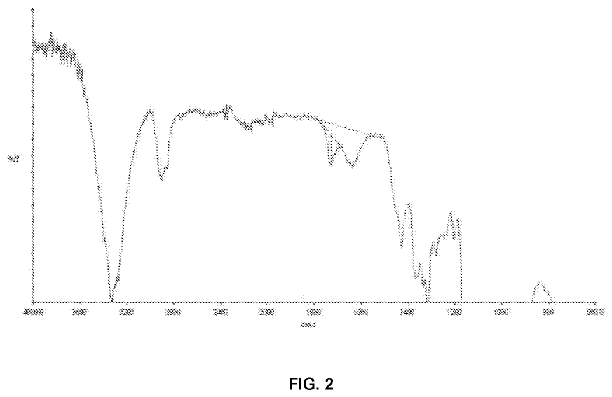

FIG. 2 shows a representative IR spectrum for a fabric treated as described in Example 2.

### Example 3—Lab Scale Method 3

75.2 mL water and 10 g Synperonic® F108 (as obtained from Merck; CAS number. 9003-11-6) were stirred vigorously until dissolved. 7.56 g oxalic acid was then added and stirred until dissolved. 7.2 g linoleic acid was added and the resulting emulsion was stirred until homogenous. A 10×10 cm square of cellulosic fabric was dipped in the emulsion for 1 second before being squeezed between rollers to remove excess emulsion. The wetted fabric was heated in a fan-assisted oven at 110° C. for 4 minutes, then 115° C. for 1 minute. The fabric was then washed with excess methanol and excess dichloromethane, before being dried in air at room temperature.

### Example 4—Production Scale Method

57 L water and 7.58 kg Synperonic® F108 (as obtained from Sigma-Aldrich; CAS number. 9003-11-6) mixed and stirred long enough to ensure all of the solid surfactant had dissolved—this created a foamed solution. To this 5.73 kg of oxalic acid dihydrate was added with stirring. To this solution was added 5.46 kg of linoleic acid (technical grade) with stirring until fully emulsified. The emulsion mixture was placed in a trough on the production line and 1.3 m full-width cellulosic fabric was pulled through the trough. The cellulosic fabric was then squeezed between rollers to remove excess emulsion and then passed through a 20 m stenter at 110° C. with a dwell time of 4 minutes to dry the fabric and then again with 10 m of the stenter at 60° C. and 10 m of the stenter at 115° C. with a dwell time of effectively 1 minute to effect esterification. Excess linoleic acid and unspent reagents were removed by scouring with a second pass through the production line stenter to dry the fabric.

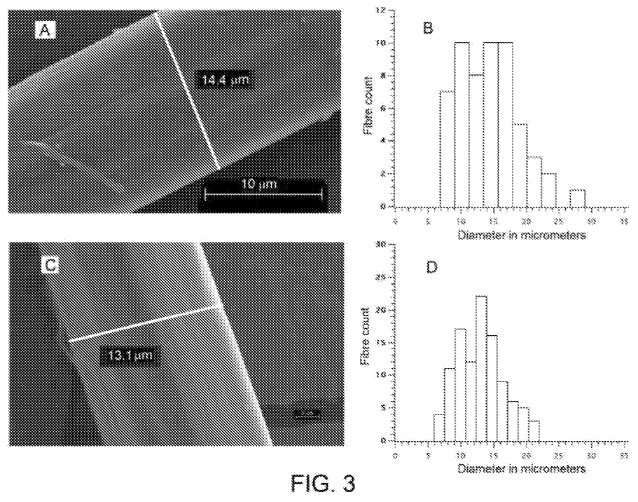

FIG. 3 shows (A) a SEM image of a representative cellulose fibre, for fabric treated as described in Example 3 (mean fibre diameter 14.4 μm); (B) the distribution of fibre diameters, for fabric treated as described in Example 3; (C) an SEM image of a representative cellulose fibre for fabric treated as described in Example 4 (mean fibre diameter 13.1 μm); and (D) the distribution of fibre diameters, for fabric treated as described in Example 4.

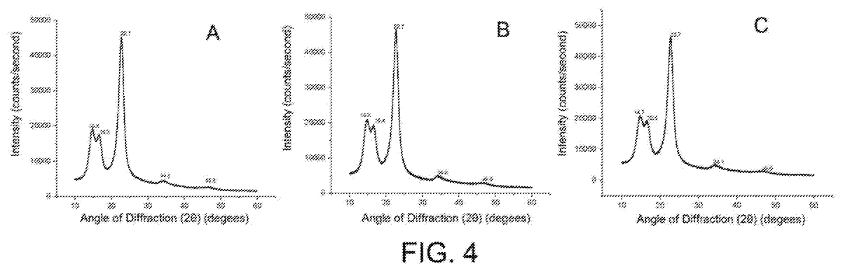

FIG. 4 shows XRD plots of intensity against 20 for untreated fabric (A), for fabric treated as described in Example 3 (B), and for fabric treated as described in Example 4 (C).

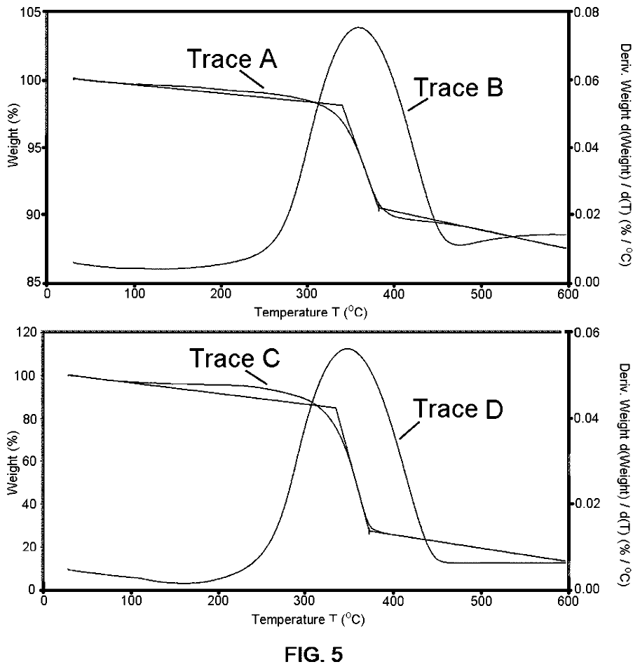

FIG. 5 shows (A, read against left-hand axis) TGA results for fabric treated as described in Example 3; (B, read against right-hand axis) DTG results for fabric treated as described in Example 3; (C, read against left-hand axis) TGA for fabric treated as described in Example 4; and (D, read against right-hand axis) DTG results for fabric treated as described in Example 4.

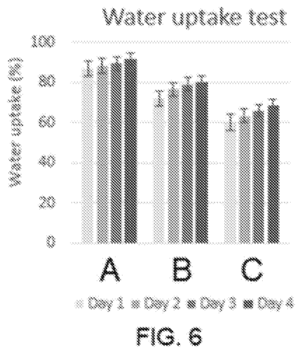

FIG. 6 shows a comparison of % weight gain after immersion in water for four days for (A) untreated fabric; (B) fabric treated as described in Example 4; (C) fabric treated as described in Example 3.

The results of the water uptake test in FIG. 6 show that modified cellulosic fabrics according to the present invention have reduced % weight gain after immersion in water compared to untreated cellulosic fabric. Thus, the modified cellulosic fabrics according to the present invention have improved resistance to water uptake versus untreated cellulosic fabric.

The foregoing broadly describes certain embodiments of the present invention without limitation. Variations and modifications as will be readily apparent to those skilled in the art are intended to be within the scope of the present invention as defined in and by the appended claims.

1. A method of modifying one or more cellulose fibres and/or cellulosic fabric, wherein the method comprises:
(a) providing an aqueous solution comprising at least one hydrocarbon acid and at least one acid catalyst and/or at least one emulsifier;
(b) treating one or more cellulose fibres and/or cellulosic fabric with the aqueous solution provided in step (a) to couple the one or more cellulose fibers and/or cellulosic fabric with the at least one hydrocarbon acid.

2. The method of claim 1, wherein the aqueous solution provided in step (a) is an emulsion.

3. The method of claim 1, wherein the at least one emulsifier is a synthetic emulsifier or a natural emulsifier.

4. The method of claim 1, wherein the at least one acid catalyst is selected from hydrochloric acid, sulfuric acid, nitric acid, methanesulfonic acid, p-toluenesulfonic acid, phosphoric acid, oxalic acid, boric acid, citric acid, trichloroacetic acid or combinations thereof.

5. The method of claim 5, wherein the at least one acid catalyst comprises oxalic acid.

6. The method of claim 1, wherein the method further comprises step (c), wherein the one or more cellulose fibres and/or cellulose fabric are squeezed using rollers to remove excess aqueous solution.

7. The method of claim 1, wherein the method further comprises step (d), wherein the treated one or more cellulose fibres and/or cellulosic fabric are heated to evaporate water and to effect esterification.

8. The method of claim 1, wherein the method further comprises step (e), wherein the one or more cellulosic fibres and/or cellulosic fabric are washed.

9. The method of claim 1, wherein the method further comprises drying step (f).

10. The method of claim 1, wherein the at least one hydrocarbon acid has a carbon number of at least about 6 and equal to or less than about 30.

11. The method of claim 1, wherein the at least one hydrocarbon acid is a fatty acid, preferably a fatty acid sourced from naturally occurring triglycerides or other natural sources.

12. The method of claim 1, wherein the at least one hydrocarbon acid is linoleic acid.

13. A composite material comprising one or more modified cellulose fibres and/or modified cellulosic fabric embedded therein obtained by the method according to claim 1.

14. The composite material obtained by the method of claim 13, wherein the composite material is biodegradable.

15. The composite material of claim 13, wherein the composite material is water resistant.

16. Use of an aqueous solution comprising at least one hydrocarbon acid and at least one acid catalyst and/or at least one emulsifier for the modification of one or more cellulosic fibres and/or cellulosic fabric.

17. The use according to claim 16, wherein the aqueous solution forms an emulsion which is stable for a time which is equal to or greater than 3 hours before phase separation.
